(19) United States
(12) Patent Application Publication
(10) Pub. No.: US 2017/0066632 A1
(43) Pub. Date: Mar. 9, 2017

(54) PORT CRANE

(71) Applicant: Terex MHPS IP Management GmbH, Düsseldorf (DE)

(72) Inventors: Mike Hegewald, Düsseldorf (DE); Peter Köhn, Düsseldorf (DE); Timo Gryzan, Bottrop (DE); Darius Schyroki, Duisburg (DE)

(21) Appl. No.: 15/119,784

(22) PCT Filed: Feb. 18, 2015
(86) PCT No.: PCT/EP2015/053434

§ 371 Date: Aug. 18, 2016

(30) Foreign Application Priority Data
Feb. 19, 2014 (DE) 10 2014 102 121.5

(51) Int. Cl. B66C 23/36; B66C 23/62

(52) U.S. Cl. CPC B66C 23/365; B66C 23/62

(57) ABSTRACT

A port crane, such as a mobile port crane, comprising an undercarriage and a superstructure that is attached onto the undercarriage, such as in a rotatable manner. The undercarriage has a modular design such that the undercarriage can be connected to different chassis via modular adapter components in a selective manner so that the selected chassis on the undercarriage is designed as a conventional undercarriage chassis. The undercarriage can alternatively be connected to different chassis via modular adapter components in a selective manner such that the selected chassis on the undercarriage is designed as a port chassis.

The present application claims the priority benefits of International Patent Application No. PCT/EP2015/053434, filed Feb. 15, 2015, and claims benefit of DE 102014102121.5, filed on Feb. 19, 2014.

### BACKGROUND OF THE INVENTION

The invention relates to a port crane, in particular a mobile port crane, comprising an undercarriage and a superstructure which is attached to the undercarriage and is preferably attached to the undercarriage in a rotatable manner, wherein the undercarriage has a modular design such that the undercarriage can be connected to different running gear units via modular adapter components in a selective manner so that the selected running gear unit on the undercarriage is designed as a conventional undercarriage running gear unit.

A crane which in this sense comprises an undercarriage which has a modular design and, with a conventional undercarriage running gear unit being formed, can be selectively connected to a wheel running gear unit or a crawler running gear unit is described e.g. in German patent document DE 30 13 513 C3 and European laid-open document EP 1 209 118 A1.

US laid-open document U.S. Pat. No. 3,638,805 A also discloses a crane comprising a conventional undercarriage running gear unit, of which the crawler running gear unit can be detachably attached and replaced by a wheel running gear unit.

For example, a so-called mobile port crane is disclosed in DE 199 44 927 C2. These port cranes comprise conventional undercarriage running gear units e.g. in the form of undercarriage tyre running gear units or undercarriage crawler running gear units and are referred to as mobile port cranes.

If the corresponding port cranes comprise a gantry running gear unit in the form of a gantry tyre running gear unit, gantry rail running gear unit or gantry crawler running gear unit, they are referred to as port gantry cranes accordingly. Their running gear unit and classification, i.e. lifting capability or bearing load, are each adapted to the intended use, i.e. such port cranes are essentially individual constructions with regard to their intended use and customer requirements.

In this regard, a conventional undercarriage running gear unit is understood to be a running gear unit which has a small clear space below the undercarriage. In contrast thereto, a gantry running gear unit is understood to be a running gear unit which below the undercarriage has a large clear space which is designed and dimensioned such that it can be used as a possible thoroughfare for vehicles operating in a container terminal or wharf. The clear space of the gantry running gear unit is defined in this case substantially by two mutually spaced apart, vertically extending gantry supports of the gantry running gear unit, in particular by their distance with respect to one another and their length between their lower end facing towards the ground and their opposite upper end. As a result, it is possible in particular for e.g. container transport vehicles which are loaded with a container, or trucks vehicles to be able to travel through at least in a single lane or even in two parallel traffic lanes without collision underneath the gantry running gear unit or between its gantry supports, in order thus to be able to travel underneath the gantry running gear unit or the undercarriage. Conversely, by reason of the clear space below the undercarriage, which space is large in comparison with conventional undercarriage running gear units, it is possible to travel over corresponding vehicles without collision by means of such a gantry running gear unit. Rail traffic can also be guided below the gantry running gear unit or between its gantry supports. Not all of this is possible with a conventional undercarriage running gear unit because its clear space below the undercarriage is not designed to be large enough for this purpose.

The brochure “Generation 5—Hafenkran-Modell 8” by Gottwald Port Technology GmbH, Dusseldorf, Germany discloses on page 5 the production of the respective port crane with a platform design, i.e. the superstructure with the tower and jib are each available with different undercarriages. The types of undercarriages described include, in addition to a version comprising tyres, a gantry design comprising a rail running gear unit and a use on a pontoon.

### SUMMARY OF THE INVENTION

The object of the present invention is to provide an improved port crane which, with regard to the running gear unit which can be connected to the modular undercarriage, can be adapted in a simple manner to suit different uses and situations.

In accordance with an embodiment of the invention, a port crane, in particular a mobile port crane, comprising an undercarriage and a superstructure which is attached to the undercarriage and is preferably attached to the undercarriage in a rotatable manner, wherein the undercarriage has a modular design such that the undercarriage can be connected to different running gear units via modular adapter components in a selective manner so that the selected running gear unit on the undercarriage is designed as a conventional undercarriage running gear unit, is improved by virtue of the fact that the undercarriage can be connected alternatively to different running gear units via modular adapter components in a selective manner so that the selected running gear unit on the undercarriage is designed as a gantry running gear unit. Therefore, the port crane has a modular design with regard to the running gear unit formed on the undercarriage and can be adapted in an extremely simple manner by modifying the individual modules and adapter components used for the undercarriage so as to suit the intended use and customer requirements, such as e.g. the running gear unit span widths required by customers and the desired clear space below the undercarriage. By virtue of the corresponding modular design of the undercarriage which allows a gantry running gear unit, under which vehicles can travel, to be formed on the undercarriage, the port crane can be adapted to suit the circumstances prevailing at the site of use. In this manner, the traffic routes can be optimised in a space-saving manner even in relatively small container terminals and constricted wharfs and the accessibility to the area directly surrounding the port crane can be improved. Furthermore, certain aspects relating to series production can thus be incorporated into the production of the undercarriage or the components or adapter components and modules which allow more economical production.

In the preferred embodiment, the undercarriage comprises a central box-shaped component which, in addition to the rotating assembly, comprises connections for the modular adapter components and/or modules on its end sides and/or its longitudinal sides and/or its underside. For instance, the undercarriage is constructed around this universal component, in that the modules or adapters are fastened to the connections. In the simplest case, the connections are connection surfaces for welding the adapters/modules.

The undercarriage is thus constructed around an always identical central component by means of the adapter components and other modules fastened thereto. The modules are thus fastened to the central component either directly or in the same manner as the respective running gear unit by means of the adapter components, in order to construct the entire undercarriage.

In a structurally simple manner, provision is made that in order to form the gantry running gear unit, two main side running gear unit girders can be connected to the undercarriage which can be connected to one of the different running gear units in a selective manner, preferably to a tyre running gear unit, in particular in the form of individually steered and height-adjustable pendulum axles comprising tyres, or to a rail running gear unit, in order to form gantry supports of the gantry running gear unit.

In an advantageous manner, provision is also made that on both end sides of the horizontally extending central component, each one of the vertically extending main side running gear unit girders can be connected to the central component.

In a structurally simple manner, provision is also made that each main side running gear unit girder can be connected to the central component via a modular adapter component designed as an adapter, wherein the adapter is designed preferably in an angular manner and can be fastened to the respective end side via one of the connections.

For instance, the central component can be produced by using suitable bent adapter components e.g. in a simple manner with main side running gear unit girders in a gantry design. Alternatively, rails or tyre running gear units can likewise be attached to the gantry created in this way. In the case of the tyre running gear unit, jib supports can additionally be provided in the region of the running gear unit.

In an advantageous manner, provision is made that in order to form the conventional undercarriage running gear unit, modular adapter components designed as a fastening arm or as a fastening support can be connected to the central component, in order thereby to connect the undercarriage to one of the different running gear units in a selective manner, preferably to a tyre running gear unit, in particular in the form of individually steered and height-adjustable pendulum axles comprising tyres or in the form of a conventional tyre running gear unit, wherein the connection of the modular adapter components to the central component is possible in particular via the connections on the longitudinal sides and/or the underside of the central component and/or via end carriages which can be connected to the two end sides of the central component.

Accordingly, the central component can be provided with conventional running gear units comprising tyres. As an alternative thereto, it is also possible to use individually steered and height-adjustable pendulum axles comprising tyres. They can also be provided, in addition to the two required running gear unit rows, in a third running gear unit row on the underside of the central component.

It is also possible, depending upon the running gear unit and intended use, that supports, in particular in the form of jib supports or brace supports, can likewise be attached to the undercarriage or to the central component via modular adapter components, and the modular adapter components preferably comprise one of the end carriages or a supporting structure which can be connected to the end carriage or the central component.

The same applies to the generator unit which can be configured as a container-like module, so that it can be arranged selectively on the longitudinal side or end side or upper side of the undercarriage. For example, it is possible to arrange the generator unit on the end side or at the end of the undercarriage on its upper side in the embodiment of the running gear unit as a conventional running gear unit comprising tyres or with individually steered and height-adjustable pendulum axles comprising tyres. In the embodiment designed in gantry form, the generator unit can be placed on the longitudinal side of the undercarriage or likewise at the end of the undercarriage on its upper side. In the case of an internal power supply of the crane, the generator unit is equipped with a modular diesel engine, a generator, a tank and the corresponding peripheral devices. In the case of an external power supply of the crane via an external power feed, said components are omitted and instead a transformer comprising corresponding peripheral devices is used, which leads to a reduction in the size of the generator housing.

In order to provide a complete port crane construction kit, it is likewise desired that the superstructure or its tower or jib also have a modular design.

Preferably, the superstructure thus comprises a tower attached thereto which comprises a jib which can be pivoted about a horizontal axis, wherein the tower can be completed in a modular manner by means of different lifting units, luffing mechanisms, jibs, counterweights and electrohydraulic units. Furthermore, the tower can be constructed adaptively (modularly) in relation to its height.

Preferred exemplified embodiments, further details, features and advantages of the invention are apparent from the description hereinafter.

### BRIEF DESCRIPTION OF THE DRAWINGS

FIG. 1 shows a schematic perspective overview of the modular design of the undercarriage in accordance with the invention;

FIG. 2 shows an embodiment of the modular undercarriage comprising individually steered and height-adjustable pendulum axle-tyre running gear units and jib supports on end carriages;

FIG. 2a shows a port crane comprising a superstructure attached to the undercarriage in accordance with FIG. 2;

FIG. 3 shows an alternative embodiment of the modular undercarriage comprising main side running gear unit girders designed in gantry form with tyre running gear units and jib supports;

FIG. 3a shows a port crane comprising a superstructure attached to the undercarriage in accordance with FIG. 3;

FIG. 4 shows a further embodiment of the modular undercarriage comprising main side running gear unit girders designed in gantry form with rail running gear units, and

FIG. 5 shows an alternative embodiment of the modular undercarriage comprising conventional tyre running gear units and jib supports on end carriages.

### DESCRIPTION OF THE PREFERRED EMBODIMENTS

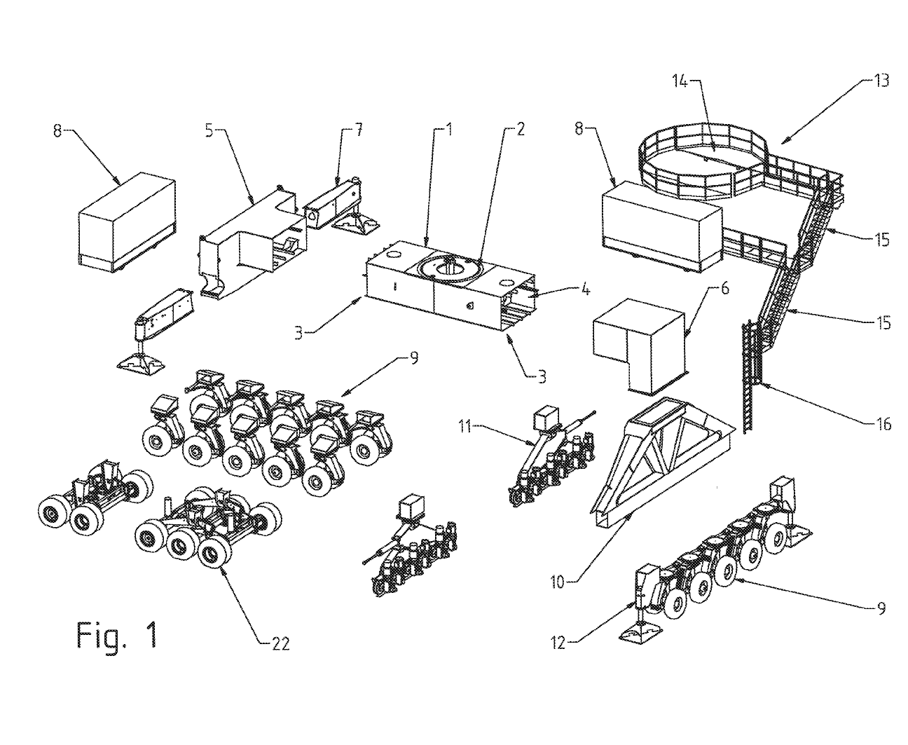

FIG. 1 shows the concept with respect to the modular design of the undercarriage of a mobile port crane with the aid of an exploded view.

Depending upon the requirements, the undercarriage can be fitted or produced with different running gear units via modular adapter components in a selective manner.

The undercarriage comprises a central box-shaped component 1 which, in addition to the rotating assembly 2, comprises connections 4 for the adapter components and/or modules on its end sides 3.

The connections 4 can be adjoined by either end carriages 5 or adapters 6.

The end carriages 5 can be fitted with jib supports 7.

A generator housing 8 can be fastened on the end side to the end carriage 5 or to its upper side. Alternatively, the generator housing 8 can also be arranged above a supporting structure 20 in parallel with the longitudinal side of the component 1, wherein the supporting structure 20 is fastened to the underside of the component 1. A clearance distance for a walkway 17 (see below) can be left between the component 1 and the generator housing.

A conventional tyre running gear unit 22 or individually steered and height-adjustable pendulum axles 9 comprising tyres as the running gear unit can be fastened laterally to the longitudinal sides of the box-shaped component 1.

The adapters 6 bend downwards and serve to secure main side running gear unit girders 10.

Depending upon use, rail running gear units 11 or individually steered and height-adjustable pendulum axles 9 comprising tyres are provided on the main side running gear unit girders 10.

The main side running gear unit girders 10 can be fitted with end-side brace supports 12.

In addition, a modular platform frame 13 is provided which comprises two pitch circle-shaped platform extensions 14 on one side, and steps 15, ladders 16 and walkways 17 on the other side.

Some of the various combination options of the modular undercarriage are demonstrated hereinafter with the aid of examples.

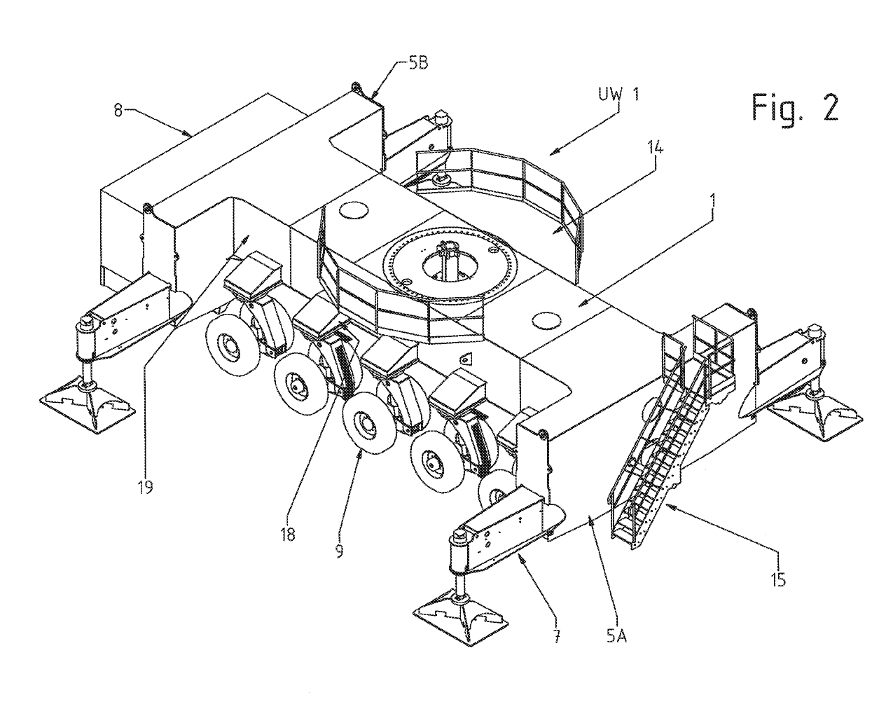

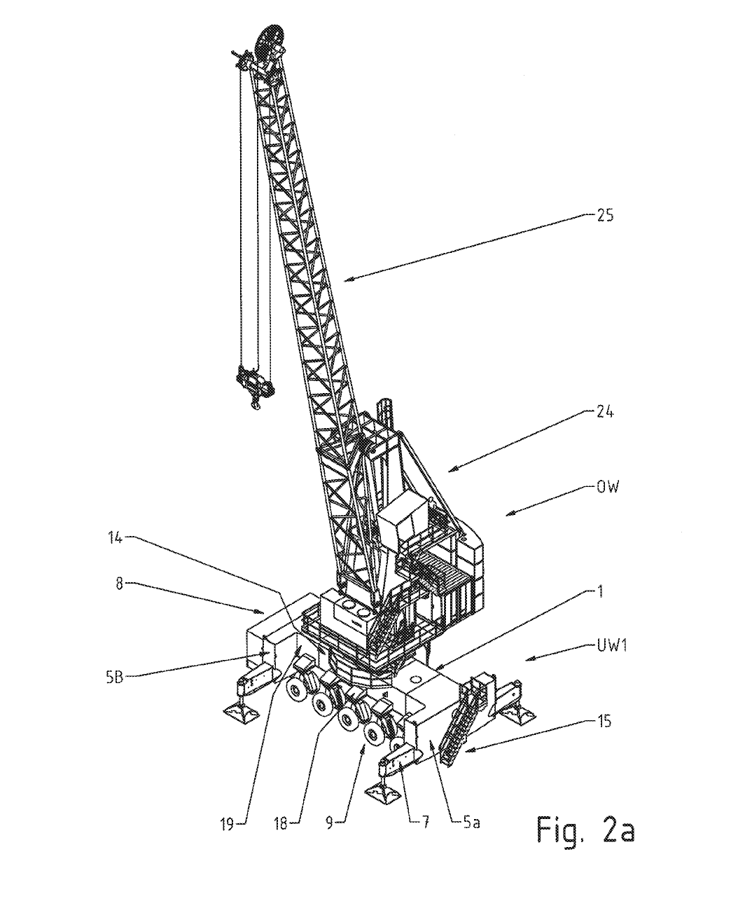

FIG. 2 shows a conventional mobile port crane undercarriage UW1. Welded to the end side of the central box-shaped component 1 are end carriages 5 which are fitted with extendible jib supports 7. One end carriage 5B also supports the generator housing 8 in container form.

The pitch circle-shaped platform extensions 14 are attached adjacent to the rotating assembly 2 and at the other end the end carriage 5A is configured having the steps 15 for access.

Individually steered and height-adjustable pendulum axles 9 (5 in each case here) comprising tyres are each arranged laterally on the longitudinal sides of the box-shaped component 1 or the regions 19 of the end carriages 5, which lengthen the longitudinal sides and are aligned therewith, by means of welded fastening arms 18.

FIG. 2a shows a complete port crane which in addition to the undercarriage UW1 shown in FIG. 2 comprises a superstructure OW which is attached thereto. The parts of the undercarriage UW1 shown in FIG. 2 are also shown in FIG. 2a and are designated by like reference signs. The undercarriage UW1 comprises a conventional undercarriage running gear unit. Attached to the superstructure OW is a tower 24 which comprises a jib 25 which can be pivoted about a horizontal axis. In this case, the tower 24 can be completed in a modular manner by means of different lifting units, luffing mechanisms, jibs, counterweights and electrohydraulic units.

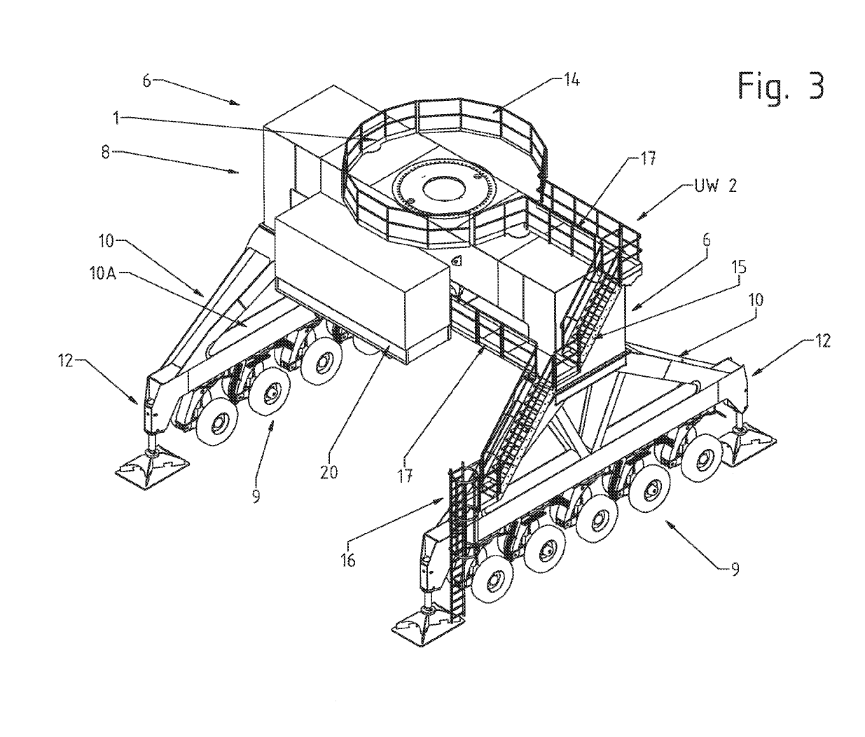

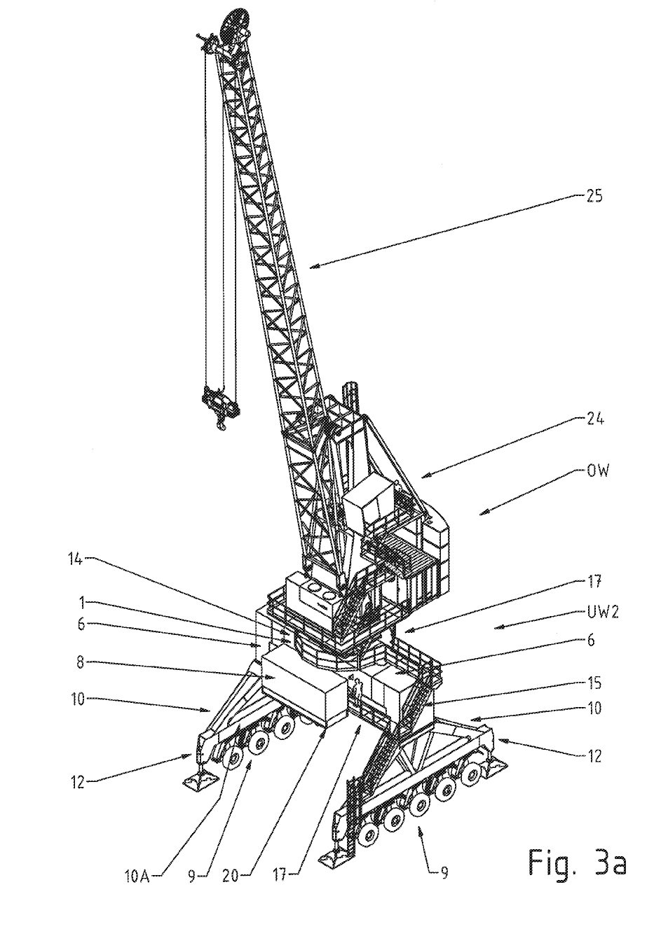

FIG. 3 shows a mobile port crane undercarriage UW2 designed in gantry form. Welded to the end side of the central box-shaped component 1 are adapters 6 which support main side running gear unit girders 10, on which in turn individually steered and height-adjustable pendulum axles 9 (5 in each case here) comprising tyres are arranged on the lowermost cross girder 10A. The two main side running gear unit girders 10 form gantry supports of the gantry running gear unit. The gantry supports also comprise the running gear units, in the present case in the form of pendulum axles 9 which are arranged on a lower end facing towards the ground. As a result, a large clear space is formed below the undercarriage UW2 and is dimensioned such that it can be used as a possible thoroughfare for vehicles operating in a container terminal or wharf. The clear space of the gantry running gear unit is defined in this case substantially by the distance between the two gantry supports with respect to one another and their length between their lower end facing towards the ground and their opposite upper end which is adjoined in each case by one of the adapters 6 and the central component 1.

The generator housing 8 in container form is now directly fastened to the central component 1 via a supporting structure 20.

The pitch circle-shaped platform extensions 14 are attached next to the rotating assembly 2 and at one end the adapter 6 is configured having walkways 17, steps 15 and ladders 16 for access, wherein the walkway 17 extends at the height of the generator housing 8 between the component 1 and generator housing 8.

FIG. 3a shows a complete port crane which, in addition to the undercarriage UW2 shown in FIG. 3, comprises a superstructure OW attached thereto. The parts of the undercarriage UW2 shown in FIG. 3 are also shown in FIG. 3a and are designated by like reference signs. The superstructure OW corresponds to the superstructure OW shown in FIG. 2a. The superstructure UW2 comprises a gantry running gear unit. It can be seen in this case that between the gantry supports which are formed by the main side running gear unit girders 10 and the running gear units, a clear space is formed which is large enough to be used as a possible thoroughfare for vehicles operating in a container terminal or wharf and accordingly vehicles are able to travel underneath the gantry running gear unit or the undercarriage UW2.

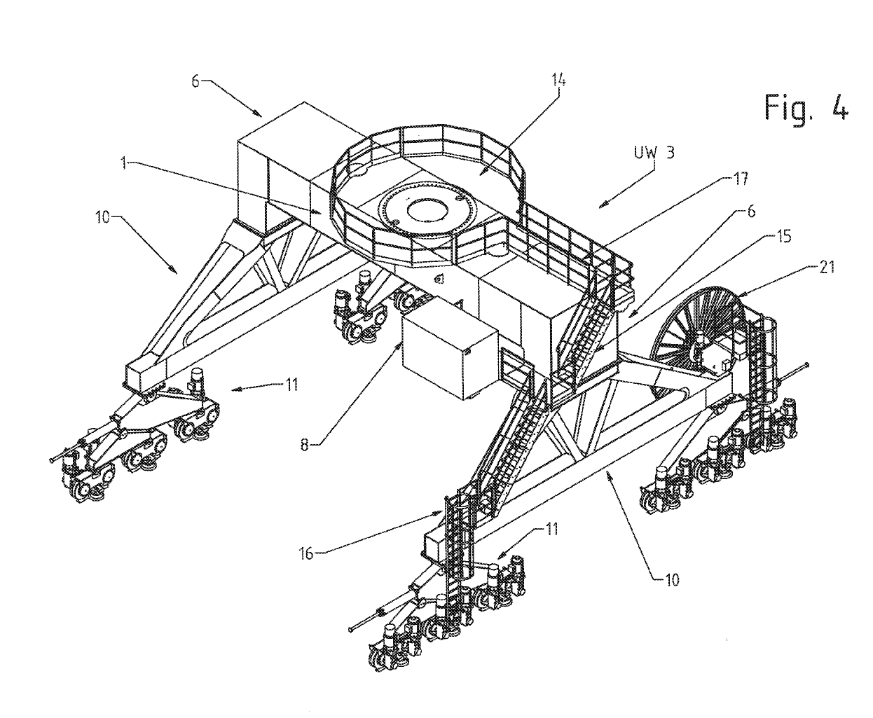

FIG. 4 shows a mobile port crane undercarriage UW3 designed in gantry form but, in contrast to FIG. 3, having rail running gear units 11 on the main side running gear unit girders 10 which now are not fitted with supports 12. For the remainder, the gantry running gear unit of the undercarriage UW3 is formed in the same manner as the gantry running gear unit of the undercarriage UW2, so that even in this case vehicles can travel underneath it.

As an alternative power supply, the mobile port crane undercarriage UW3 can be equipped, as illustrated, with an external power feed 21 and a generator housing 8 which is reduced in size and which is likewise fastened to the central component 1 by means of a supporting structure 20. This external power supply can be used in a conventionally equipped crane and also in the case of the gantry design.

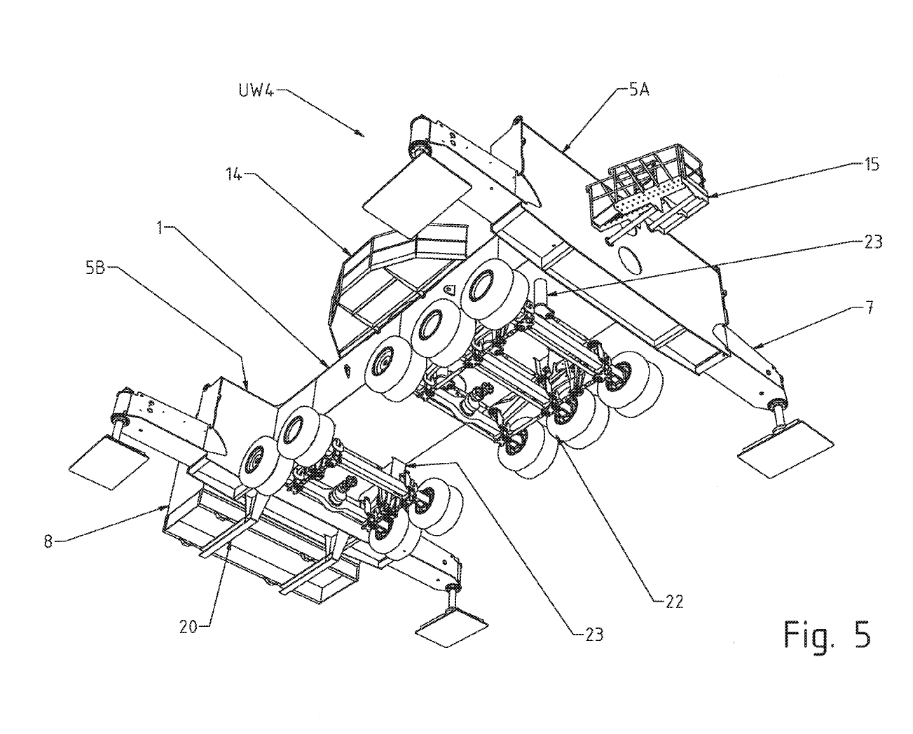

FIG. 5 shows a conventional mobile port crane undercarriage UW4 in which, in contrast to FIG. 2, a conventional tyre running gear unit 22 has been installed. For this purpose, the tyre running gear unit 22 is attached to the underside of the central component 1 via fastening supports 23 which serve as adapters.

The fastening supports 23 serve on the one hand to support the transverse control arms and, on the other hand, to support the axle suspensions and are welded to the central component 1 and are fastened to the transverse control arms or axle suspension by means of bolts.

### LIST OF REFERENCE SIGNS

1 box-shaped component

2 rotating assembly

3 end side

4 connection

5 end carriage

5A first end carriage

5B second end carriage

6 adapter

7 jib support

8 generator housing

9 individually steered and height-adjustable pendulum axle comprising tyres

10 main side running gear unit girder

10A cross girder

11 rail running gear unit

12 brace support

13 platform frame

14 platform extension

15 steps

16 ladders

17 walkway

18 fastening arm

19 aligned region

20 supporting structure

21 external power feed

22 conventional tyre running gear unit

23 fastening supports

24 tower

25 jib

OW superstructure

UW1 undercarriage

UW2 undercarriage

UW3 undercarriage

UW4 undercarriage

1. A port crane, the port crane comprising an undercarriage and a superstructure which is attached to the undercarriage in a rotatable manner, wherein the undercarriage has a modular design such that the undercarriage can be connected to different running gear units via modular adapter components in a selective manner so that the selected running gear unit on the undercarriage is designed as a conventional undercarriage running gear unit, and the conventional undercarriage running gear unit has a clear space which is designed and dimensioned to be so small that a container transport vehicle and a conventional truck cannot travel therethrough below the undercarriage without collision, and wherein the undercarriage can be connected alternatively to different running gear units via modular adapter components in a selective manner so that the selected running gear unit on the undercarriage is designed as a gantry running gear unit and the gantry running gear unit has a clear space which is designed and dimensioned such that container transport vehicles which are loaded with a container, or trucks vehicles are able to travel through at least in a single lane without collision underneath the gantry running gear unit or between its gantry supports, in order thus to be able to travel underneath the gantry running gear unit, and in that the undercarriage comprises a central box-shaped component which, in addition to a rotating assembly, comprises connections for the modular adapter components on its end sides and/or its longitudinal sides and/or its underside.

2. The port crane as claimed in claim 1, wherein in order to form the gantry running gear unit, two main side running gear unit girders can be connected to the undercarriage which can be connected to one of the different running gear units in a selective manner in order to form gantry supports of the gantry running gear unit, and wherein the different running gear units comprise a tire running gear unit in the form of individually steered and height-adjustable pendulum axles comprising tires or a rail running gear unit.

3. The port crane as claimed in claim 2, wherein on both end sides of the horizontally extending central component, each one of the vertically extending main side running gear unit girders can be connected to the central component.

4. The port crane as claimed in claim 3, wherein each main side running gear unit girder can be connected to the central component via a modular adapter component designed as an adapter, wherein the adapter is designed in an angular manner and can be fastened to the respective end side via one of the connections.

5. The port crane as claimed in claim 4, wherein in order to form the conventional undercarriage running gear unit, modular adapter components designed as a fastening arm or as a fastening support can be connected to the central component, in order thereby to connect the undercarriage to one of the different running gear units in a selective manner, wherein the different running gear units comprise a tire running gear unit in the form of individually steered and height-adjustable pendulum axles comprising tires or in the form of a conventional tire running gear unit, and wherein the connection of the modular adapter components to the central component is achieved via the connections on the longitudinal sides and/or the underside of the central component and/or via end carriages which can be connected to the two end sides of the central component.

6. The port crane as claimed in claim 5, wherein supports in the form of jib supports or brace supports can likewise be attached to the undercarriage via modular adapter components, and the modular adapter components comprise one of the end carriages or one of the adapters which can be connected to the two end sides of the central component.

7. The port crane as claimed in claim 6, wherein a generator housing can likewise be attached to the undercarriage via modular adapter components, and the modular adapter components comprise one of the end carriages or a supporting structure which can be connected to the end carriage or the central component.

8. The port crane as claimed in claim 1, wherein the superstructure comprises a tower which is attached thereto and comprises a jib which can be pivoted about a horizontal axis, wherein the tower can be completed in a modular manner by means of different lifting units, luffing mechanisms, jibs, counterweights and electrohydraulic units.

9. The port crane as claimed in claim 8, wherein the tower is constructed adaptively in relation to height.

10. The port crane as claimed in claim 2, wherein each main side running gear unit girder can be connected to the central component via a modular adapter component designed as an adapter.

11. The port crane as claimed in claim 10, wherein the adapter is designed in an angular manner and can be fastened to the respective end side via one of the connections.

12. The port crane as claimed in claim 1, wherein in order to form the gantry running gear unit, two main side running gear unit girders can be connected to the undercarriage.

13. The port crane as claimed in claim 12, wherein the running gear unit girders are configured to selectively receive differently configured running gear units in order to form gantry supports of the gantry running gear unit.

14. The port crane as claimed in claim 1, wherein in order to form the conventional undercarriage running gear unit, modular adapter components designed as a fastening arm or as a fastening support can be connected to the central component, in order thereby to connect the undercarriage to one of the different running gear units in a selective manner.

15. The port crane as claimed in claim 14, wherein the different running gear units comprise a tire running gear unit in the form of individually steered and height-adjustable pendulum axles comprising tires or in the form of a conventional tire running gear unit.

16. The port crane as claimed in claim 14, wherein the connection of the fastening arm or as fastening support to the central component is achieved via the connections on the longitudinal sides and/or the underside of the central component and/or via end carriages which can be connected to the two end sides of the central component.

17. The port crane as claimed in claim 1, wherein supports are attachable to the undercarriage.

18. The port crane as claimed in claim 17, wherein the supports comprise jib supports or brace supports, and wherein the supports are attachable to the undercarriage by modular adapter components that comprise one of the end carriages or one of the adapters which can be connected to the two end sides of the central component.

19. Port crane as claimed in claim 1, wherein a generator housing is attachable to the undercarriage.

20. Port crane as claimed in claim 19, wherein the generator is attachable to the undercarriage by modular adapter components that comprise one of the end carriages or a supporting structure which can be connected to the end carriage or the central component.
